(19) United States
(12) Patent Application Publication
(10) Pub. No.: US 2007/0080074 A1
(43) Pub. Date: Apr. 12, 2007

(54) Multicell ammonia sensor and method of use thereof

(75) Inventors: Da Yu Wang, Troy, MI (US); Walter T. Symons, Grand Blanc, MI (US); Robert Jerome Farhat, Grosse Point Park, MI (US); Sheng Yao, Macomb, MI (US)

Correspondence Address: Paul L. Marshall;Delphi Technologies, Inc., M/C 480-410-202, P.O. Box 5052, Troy, MI, 48007, US

(73) Assignee: Delphi Technologies, Inc., Troy, MI (US)

(21) Appl. No.: 11/538,240

(22) Filed: Oct. 3, 2006

Related U.S. Application Data
(60) Provisional application No. 60/725,054, filed on Oct. 7, 2005.

(51) Int. Cl. G01F 1/64; G01N 27/26

(52) U.S. Cl. 205/780.5; 204/424

(57) ABSTRACT

Disclosed herein are methods of sensing NH₃ in a gas and sensors therefore. In one embodiment, a method of sensing NH₃ in a gas comprises: contacting a NOx electrode with the gas, and determining if a NOx emf between the NOx electrode and a reference electrode is greater than a selected emf. If the NOx emf is greater than the selected emf, a NH₃ emf between an NH₃ electrode and the reference electrode is determined. If the NOx emf is not greater than the selected emf, a NH₃ emf between the NH₃ electrode and the NOx electrode is determined.

### CROSS REFERENCE TO RELATED APPLICATIONS

This application claims priority to U.S. Provisional Application No. 60/725,054, filed Oct. 7, 2005, which is incorporated herein by reference in its entirety.

### BACKGROUND

Exhaust gas generated by combustion of fossil fuels in furnaces, ovens, and engines contain, for example, nitrogen oxides (NO_{X}), unburned hydrocarbons (HC), and carbon monoxide (CO). Vehicles, e.g., diesel vehicles, utilize various pollution-control after treatment devices (such as a NO_{X} absorber(s) and/or selective catalytic reduction (SCR) catalyst(s)), to reduce NO_{X}. For diesel vehicles using SCR catalysts, NO_{X} reduction can be accomplished by using ammonia gas (NH₃). In order for SCR catalysts to work efficiently and to avoid pollution breakthrough, an effective feedback control loop is needed. To develop such technology, the control system needs reliable commercial ammonia sensors.

One group of ammonia sensor designs operate based on the Nernst Principle, where the sensor converts chemical energy from NH₃ into electromotive force (emf). The sensor can measure this electromotive force to determine the partial pressure of NH₃ in a sample gas. However, these sensors also convert the chemical energy from NO_{X} gas into electromotive force. Therefore, when determining partial pressure based on electromotive force, the sensor is not able to effectively distinguish between NH₃ and NO_{X}.

Therefore, the control system would benefit from a sensor that can measure the partial pressure of NH₃ in the presence of NO_{X}.

### SUMMARY

Disclosed herein are methods of sensing ammonia, and sensors therefore. In one embodiment, a method of sensing NH₃ in a gas comprises: contacting a NOx electrode with the gas, and determining if a NOx emf between the NOx electrode and a reference electrode is greater than a selected emf. If the NOx emf is greater than the selected emf, a NH₃ emf between an NH₃ electrode and the reference electrode is determined. If the NOx emf is not greater than the selected emf, a NH₃ emf between the NH₃ electrode and the NOx electrode is determined.

In another embodiment, a method of sensing NH₃ in a gas can comprise: contacting a NOx electrode with the gas, and determining if a NOx emf between the NOx electrode and a first reference electrode is greater than a selected emf. If the NOx emf is greater than the selected emf, a NH₃ emf between an NH₃ electrode and a second reference electrode can be determined. If the NOx emf is not greater than the selected emf, the NH₃ emf between the NH₃ electrode and the NOx electrode can be determined.

In one embodiment, the sensor can comprise: an NH₃ sensing cell comprising a NH₃ electrode and a reference electrode, with an electrolyte disposed therebetween and in ionic communication therewith, a first electrical lead in physical contact with the NH₃ electrode, a reference electrical lead in physical contact with the reference electrode, and a NO_{X} sensing cell comprising a NOx electrode and the reference electrode, with the electrolyte disposed therebetween and in ionic communication therewith. A second electrical lead can be in physical contact with the NOx electrode. The NO_{X} sensing cell is capable of detecting a NO_{X} electromotive force. The third sensing cell comprises the NH₃ electrode, the NOx electrode, and the electrolyte. The sensor can be capable of sensing ammonia at the NH₃ sensing cell and at the third sensing cell.

The above described and other features are exemplified by the following figures and detailed description.

### DRAWINGS

Refer now to the figures, which are exemplary embodiments, and wherein like elements are numbered alike.

FIG. 1 is an exploded view of an exemplary planar sensor element.

FIG. 2 is a graphical representation of the voltage across an NH₃ cell, the voltage across a NO_{X} cell, and the voltage across an NH₃—NOₓ cell, at selected partial pressures of NO_{X} and of NH₃ in a sample gas.

### DETAILED DESCRIPTION

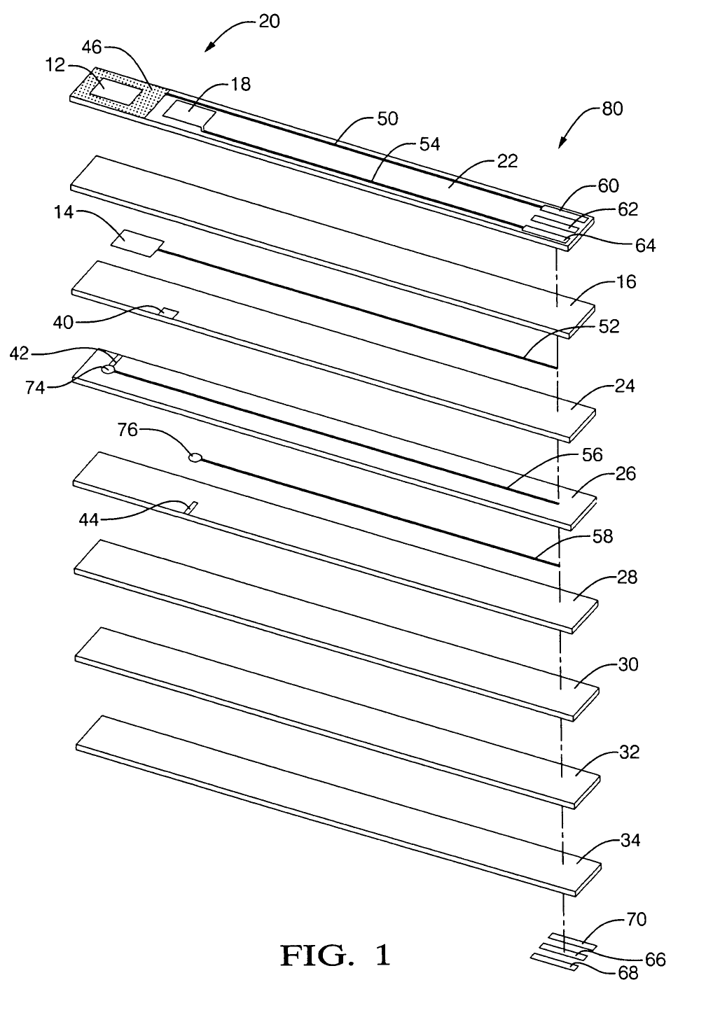

Referring to FIG. 1, in an exemplary embodiment, a sensor element 10 comprises a NH₃ sensing cell; comprising a NH₃ electrode 12, a reference electrode 14 and an electrolyte 16 (12/16/14), a NO_{X} sensing cell, comprising a NOx electrode 18, the reference electrode 14 and the electrolyte 16 (18/16/14), and an NH₃ —NO_{X} sensing cell, comprising the NH₃ and NOx electrodes 12, 18 and the electrolyte 16 (12/16/18). The NH₃ sensing cell 12/16/14, the NO_{X} sensing cell 18/16/14, and the NO_{X} —NH₃ sensing cell 12/16/18 are disposed at a sensing end 20 of the sensor element 10. The sensor comprises insulating layers 22, 24, 28, 30, 32, 34, and active layers, which include layer 26 and the electrolyte layer 16. The active layers can conduct oxygen ions, where the insulating layers can insulate sensor components from electrical and ionic conduction and/or provide structural integrity. In an exemplary embodiment, the electrolyte layer 16 is disposed between insulating layers 22 and 24, and active layer 26 is disposed between insulating layers 24 and 28.

The sensor element 10 can further comprise, a temperature sensing cell (and/or air to fuel ratio sensor) comprising the active layer 26 and electrodes 74 and 76 (74/26/76), a heater (not shown), and/or an electromagnetic force shield (not shown). An inlet 40 can be defined by a first surface of the insulating layer 24, and by a surface of the electrolyte 16, proximate reference electrode 14. An inlet 42 can be defined by a first surface of the active layer 26 and by a second surface of the insulating layer 24. An inlet 44 can be defined by a surface of the layer 28 and a second surface of the active electrolyte layer 26. In addition, the sensor element 10 can comprise a current collector 46, electrical leads 50, 52, 54, 56, 58, contact pads 60, 62, 64, 66, 68, 70, ground plane (not shown), ground plane layers(s) (not shown), and the like.

For placement in a gas stream, sensor element 10 can be disposed within a protective casing (not shown) having holes, slits, and/or apertures, which can optionally act to generally limit the overall exhaust gas flow in physical communication with sensor element 10.

The NH₃ electrode 12 is disposed in physical and ionic communication with the electrolyte 16 and can be disposed in fluid communication with a sample gas (e.g., a gas being monitored or tested for its ammonia concentration). Under the operating conditions of the sensor element 10, the general properties of the NH₃ electrode material include NH₃ sensing capability (e.g., catalyzing NH₃ gas to produce an electromotive force (emf)), electrical conducting capability (conducting electrical current produced by the emf), and gas diffusion capability (providing sufficient open porosity so that gas can diffuse throughout the electrode and to the interface region of the NH₃ electrode 12 and the electrolyte 16). Possible NH₃ electrode materials include first oxide compounds of vanadium (V), tungsten (W), and molybdenum (Mo), as well as combinations comprising at least one of the foregoing, which can be doped with second oxide components, which can increase the electrical conductivity or enhance the NH₃ sensing sensitivity and/or NH₃ sensing selectivity to the first oxide components. Exemplary first components include the ternary vanadate compounds such as bismuth vanadium oxide (BiVO₄), copper vanadium oxide (Cu₂(VO₃)₂), ternary oxides of tungsten, and/or ternary molybdenum (MoO₃), as well as combinations comprising at least one of the foregoing. Exemplary second component metals include oxides such as alkali oxides, alkali earth oxides, transition metal oxides, rare earth oxides, and oxides such as SiO₂, ZnO, SnO, PbO, TiO₂, In₂O₃, Ga₂O₃, Al₂O₃, GeO, and Bi₂O₃, as well as combinations comprising at least one of the foregoing. The NH₃ electrode material can also include traditional oxide electrolyte materials such as zirconia, doped zirconia, ceria, doped ceria, or SiO₂, Al₂O₃ and the like, e.g., to form porosity and increase the contact area between the NH₃ electrode material and the electrolyte. Additives of low soft point glass frit materials can be added to the electrode materials as binders to bind the electrode materials to the surface of the electrolyte. Further examples of NH₃ sensing electrode materials can be found in U.S. patent Ser. No. 10/734,018, to Wang et al., and commonly assigned herewith.

The current collector 46 is disposed in physical contact and electrical communication with a periphery of the NH₃ electrode 12 and the electrical lead 50. The current collector 46 is disposed so as to have minimal, and more specifically, no physical contact with the electrolyte 16. Under the operating conditions of the sensor element 10, the general properties of the current collector 46 include (i) electrical conducting capability (ability to collect and conduct current), and (ii) low or no catalytic, electrochemical, and chemical reactivity (e.g., so as not to significantly react with the sample gas). Possible materials for the current collector can include non-reactive gold (Au), platinum (Pt), palladium (Pd), rhodium (Rh), as well as combinations comprising at least one of the foregoing (e.g., gold platinum alloys (Au—Pt), gold palladium alloys (Au—Pd), that have been processed to have the desired chemical reactivity). Other examples include unalloyed Group VIII refractory metals such as iridium (Ir), osmium (Os), ruthenium (Ru), and rhodium (Rh). Current collector 46 can include additives to reduce the material's reactivity with the sample gas. For example, stuffing Pt with alumina (Al₂O₃) and/or with silica (SiO₂) will decrease gas reactivity by eliminating the porosity of the material, decreasing the surface area available for gas reactions, and rendering the Pt non-reactive.

The reference electrode 14 is disposed in physical contact and ionic communication with the electrolyte 16 and can be disposed in fluid communication with the sample gas or reference gas; preferably with the sample gas. Under the operating conditions of sensor element 10, the general properties of the material forming the reference electrode 14 include: equilibrium oxygen catalyzing capability (e.g., catalyzing equilibrium O₂ gas to produce an emf), electrical conducting capability (conducting electrical current produced by the emf), and gas diffusion capability (providing sufficient open porosity so that gas can diffuse throughout the electrode and to the interface region of the electrode 14 and electrolyte 16). Possible electrode materials include platinum (Pt), palladium (Pd), osmium (Os), rhodium (Rh), iridium (Ir), gold (Au), and ruthenium (Ru), as well as combinations comprising at least one of the foregoing materials. The electrode can include metal oxides such as zirconia and/or alumina that can increase the electrode porosity and increase the contact area between the electrode and the electrolyte. In another embodiment, the reference electrode 14 can comprise two separate reference electrodes. In this embodiment, one reference electrode could be disposed in electrical and ionic communication with the NH₃ sensing cell and a different reference electrode could be disposed in electrical and ionic communication with the NO_{X} sensing cell.

The NOx electrode 18 is disposed in physical contact and ionic communication with the electrolyte 16 and can be disposed in fluid communication with the sample gas. Under the operating conditions of sensor element 10, the general properties of the NOx electrode material(s) include, NO_{X} sensing capability (e.g., catalyzing NO_{X} gas to produce an emf), electrical conducting capability (conducting electrical current produced by the emf), and gas diffusion capability (providing sufficient open porosity so that gas can diffuse throughout the electrode and to the interface region of the electrode and electrolyte). These materials can include oxides of ytterbium, chromium, europium, erbium, zinc, neodymium, iron, magnesium, gadolinium, terbium, chromium, as well as combinations comprising at least one of the foregoing, such as YbCrO₃, LaCrO₃, ErCrO₃, EuCrO₃, SmCrO₃, HoCrO₃, GdCrO₃, NdCrO₃, ThCrO₃, ZnFe₂O₄, MgFe₂O₄, and ZnCr₂O₄, as well as combinations comprising at least one of the foregoing. Further, the NO_{X} electrode can comprise dopants that enhance the material(s)′ NOx sensitivity and selectivity and electrical conductivity at the operating temperature. These dopants can include one or more of the following elements: Ba (barium), Ti (titanium), Ta (tantalum), K (potassium), Ca (calcium), Sr (strontium), V (vanadium), Ag (silver), Cd (cadmium), Pb (lead), W (tungsten), Sn (tin), Sm (samarium), Eu (europium), Er (Erbium), Mn (manganese), Ni (nickel), Zn (zinc), Na (sodium), Zr (zirconium), Nb (niobium), Co (cobalt), Mg (magnesium), Rh (rhodium), Nd (neodymium), Gd (gadolinium), and Ho (holmium), as well as combinations comprising at least one of the foregoing dopants.

Under the operating conditions of the sensor element 10, a general property of the electrolyte 16 is oxygen ion conducting capability. It can be dense for fluid separation (limiting fluid communication of the gases on each side of the electrolyte 16) or porous to allow fluid communication between the two sides of the electrolyte. The electrolyte 16 can comprise any size such as the entire length and width of the sensor element 10 or any portion thereof that provides sufficient ionic communication for the NH₃ cell (12/16/14), for the NO_{X} cell (18/16/14), and for the NH₃—NO_{X} cell (12/16/18). Possible electrolyte materials include zirconium oxide (zirconia) and/or cerium oxide (ceria), LaGaO₃, SrCeO₃, BaCeO₃, CaZrO₃, e.g., doped with calcium oxide, yttrium oxide (yttria), lanthanum oxide, magnesium oxide, alumina oxide, and indium oxide, as well as combinations comprising at least one of the foregoing electrolyte materials, such as yttria doped zirconia, and the like.

The temperature sensing cell (74/26/76) can detect temperature of the sensing end 20 of the sensing element. The gas inlet 42 and 44 are to provide oxygen from the exhaust to the active layer 26 (e.g., an electrolyte layer) and avoid electrolyte 26 from being reduced electrically during the temperature measurement (electrolyte impedance method). The temperature sensor can be any shape and can comprise any temperature sensor capable of monitoring the temperature of the sensing end 20 of the sensor element 10, such as, for example, an impedance-measuring device or a metal-like resistance-measuring device. The metal-like resistance temperature sensor can comprise, for example, a line pattern (connected parallel lines, serpentine, and/or the like). Some possible materials include, but are not limited to, electrically conductive materials such as metals including platinum (Pt), copper (Cu), silver (Ag), palladium (Pd), gold (Au), and tungsten (W), as well as combinations comprising at least one of the foregoing.

A heater (not shown) can be employed to maintain the sensor element 10 at a selected operating temperature. The heater can be positioned as part of the monolithic design of the sensor element 10, for example between insulating layer 32 and insulating layer 34, in thermal communication with the temperature sensing cell 42/26/44 and the sensing cells 12/16/14, 18/16/14, and 12/16/18. In other embodiments, the heater could be in thermal communication with the cells without necessarily being part of a monolithic laminate structure with them, e.g., simply by being in close physical proximity to a cell. More particularly, the heater can be capable of maintaining the sensing end 20 of the sensor element 10 at a sufficient temperature to facilitate the various electrochemical reactions therein. The heater can be a resistance heater and can comprise a line pattern (connected parallel lines, serpentine, palladium, and combinations comprising at least one of the foregoing. Contact pads, for example the fourth contact pad 66 and the fifth contact pad 68, can transfer current to the heater from an external power source.

Disposed between the insulating layer 32 and another insulating layer (not shown) can be an electromagnetic shield (not shown). The electromagnetic shield isolates electrical influences by dispersing electrical interferences and creating a barrier between a high power source (such as the heater) and a low power source (such as the temperature sensor and the gas sensing cells). The shield can comprise, for example, a line pattern (connected parallel lines, serpentine, cross hatch pattern and/or the like). Some possible materials for the shield can include those materials discussed above in relation to the heater.

The first, second, and third electrical leads 50, 52, 54, are disposed in electrical communication with the first, second, and third contact pads 60, 62, 64, respectively, at the terminal end 80 of the sensor element 10. The fourth electrical lead 56 is disposed in electrical communication with the second contact pad 62. The fifth electrical lead 58 is disposed in electrical communication with the fourth contact pad 66. The fifth and sixth contact pads 68 and 70 can be used to supply electrical current from an external power source to cell components (e.g., the heater). The second, fourth, and fifth leads 52, 56, 58, are in electrical communication with the contacts pads through vias formed in the layers 22, 24, 28, 30, 32, 34 of the sensor element 10. Further, the first electrical lead 50 is disposed in physical contact and in electrical communication with the current collector 46 at a sensing end 20 of the sensor element 10. The second electrical lead 52 is disposed in physical contact and electrical communication with the reference electrode 14 at the sensing end 20. The third electrical lead 54 is disposed in physical contact and electrical communication with the NOx electrode 18 at the sensing end 20. The fourth electrical lead 56 is disposed in physical contact and in electrical communication with the electrode 74 and the fifth electrical lead 58 is disposed in physical contact and electrical communication with the electrode 76 of at the sensing end 20 of the sensor element 10. The lead 54 can be put under and protected by the layer 22. The lead 50 can be protected by putting an additional insulation layer on top of it.

The electrical leads 50, 52, 54, 56, 58, and the contact pads 60, 62, 64, 66, 68, 70 can be disposed in electrical communication with a processor (not shown). The electrical leads 50,52,54, 56, and the contact-pads 60, 62, 64, 66, 68, 70, can comprise any material with relatively good electrical conducting properties under the operating conditions of the sensor element 10. Examples of these materials include gold (Au), platinum (Pt), palladium (Pd), Group VIII refractory metals such as iridium (Ir), osmium (Os), ruthenium (Ru), and rhodium (Rh), and combinations comprising at least one of the foregoing materials (e.g., gold platinum alloys (Au—Pt), gold palladium alloys (Au—Pd), and an unalloyed Group III refractory metal). Another example is material comprising aluminum and silicon, which can form a hermetic adherent coating that prevents oxidation.

The insulating layers 22, 24, 28, 30, 32, 34, can comprise a dielectric material such as alumina (i.e., aluminum oxide (Al₂O₃), and the like). Each of the insulating layers can comprise a sufficient thickness to attain the desired insulating and/or structural properties. For example, each insulating layer can have a thickness of up to about 200 micrometers or so, depending upon the number of layers employed, or, more specifically, a thickness of about 50 micrometers to about 200 micrometers. Further, the sensor element 10 can comprise additional insulating layers to isolate electrical devices, segregate gases, and/or to provide additional structural support.

The active layer 26 can comprise material that, while under the operating conditions of sensor element 10, is capable of permitting the electrochemical transfer of oxygen ions. These include the same or similar materials to those described as comprising electrolyte 16. Each active layer (including each electrolyte layer) can comprise a thickness of up to about 200 micrometers or so, depending upon the number of layers employed, or, more specifically, a thickness of about 50 micrometers to about 200 micrometers.

In an alternative arrangement, electrodes 12 and 18 can be put side by side (instead of 12 on top and 18 on bottom as shown in FIG. 1) or can be put 18 on top and 12 on the bottom.

The sensor element 10 can be formed using various ceramic-processing techniques. For example, milling processes (e.g., wet and dry milling processes including ball milling, attrition milling, vibration milling, jet milling, and the like) can be used to size ceramic powders into desired particle sizes and desired particle size distributions to obtain physical, chemical, and electrochemical properties. The ceramic powders can be mixed with plastic binders to form various shapes. For example, the structural components (e.g. insulating layers 22, 24, 28, 30, 32, and 34, the electrolyte 16 and the active layer 26) can be formed into “green” tapes by tape-casting, role-compacting, or similar processes. The non-structural components (e.g., the NH₃ electrode 12, the NOx electrode 18, and the reference electrode 14, the current collector 46, the electrical leads, and the contact pads) can be formed into tape or can be deposited onto the structural components by various ceramic-processing techniques (e.g., sputtering, painting, chemical vapor deposition, screen-printing, stenciling, and so forth).

In one embodiment, the ammonia electrode material is prepared and disposed onto the electrolyte (or the layer adjacent to the electrolyte). In this method, the primary material, e.g., in the form of an oxide, is combined with the dopant secondary material and optional other dopants, if any, simultaneously or sequentially. By either method, the materials are mixed to enable the desired incorporation of the dopant secondary material and any optional dopants into the primary material to produce the desired ammonia-selective material. For example, V₂O₅ is mixed with Bi₂O₃ and MgO by milling for about 2 to about 24 hours. The mixture is fired to about 800° C. to about 900° C. for a sufficient period of time to allow the metals to transfer into the vanadium oxide structure and produce the new formulation (e.g., BiMg_{0.05}V_{0.95}O₄₋ₓ (wherein x is the difference in the value between the stoichiometric amount of oxygen and the actual amount)), which is the reaction product of the primary material, secondary material and optional chemical stabilizing dopant, and/or diffusion impeding dopant. The period of time is dependent upon the specific temperature and the particular materials but can be about 1 hour or so. Once the ammonia-selective material has been prepared, it can be made into ink and disposed onto the desired sensor layer. The BiVO₄ is the primary NH₃ sensing material, and the dopant Mg is used to enhance its electrical conductivity.

The NOx electrode material can be prepared and disposed onto the electrolyte by similar methods. For example, Tb₄O₇ can be mixed with MgO and Cr₂O₃ with soft glass additives by milling for about 2 to about 24 hours. The mixture is fired to up to about 1,400° C. or so for a sufficient period of time to allow the metals to transfer into the oxide structure and produce the new formulation (e.g., TbCr_{0.8}Mg_{0.2}O_{2.9-x} (wherein x is the difference in the value between the stoichiometric amount of oxygen and the actual amount)), which is the reaction product of the primary material, secondary material and optional chemical stabilizing dopant, and/or diffusion impeding dopant.

The inlets 40, 42, 44 can be formed either by disposing fugitive material (material that will dissipate during the sintering process, e.g., graphite, carbon black, starch, nylon, polystyrene, latex, other insoluble organics, as well as compositions comprising one or more of the foregoing fugitive materials) or by disposing material that will leave sufficient open porosity in the fired ceramic body to allow gas diffusion therethrough. Once the “green” sensor is formed, the sensor can be sintered at a selected firing cycle to allow controlled burn-off of the binders and other organic material and to form the ceramic material with desired microstructural properties.

During use, the sensor element is disposed in a gas stream, e.g., an exhaust stream in fluid communication with engine exhaust. In addition to NH₃, O₂, and NOₓ, the sensor's operating environment can include, hydrocarbons, hydrogen, carbon monoxide, carbon dioxide, nitrogen, water, sulfur, sulfur-containing compounds, combustion radicals, such as hydrogen and hydroxyl ions, particulate matter, and the like. The temperature of the exhaust stream is dependent upon the type of engine and can be about 200° C. to about 550° C., or even about 700° C. to about 1,000° C.

The NH₃ sensing cell 12/16/14, the NO_{X} sensing cell 18/16/14, and the NOₓ—NH₃ sensing cell 12/16/18 can generate emf as described by the Nernst Equation. In the exemplary embodiment, the sample gas is introduced to the NH₃ electrode 12, the reference electrode 14 and the NOx electrode 18 and is diffused throughout the porous electrode materials. In the electrodes 12 and 18, electro-catalytic materials induce electrochemical-catalytic reactions in the sample gas. These reactions include electrochemical-catalyzing NH₃ and oxide ions to form N₂ and H₂O, electrochemical-catalyzing NO₂ to form NO, N₂ and oxide ions, and electro-catalyzing NO and oxide ions to form NO₂. Similarly, in the reference electrode 14, electrochemical-catalytic material induces electrochemical reactions in the reference gas, primarily converting equilibrium oxygen gas (O₂) to oxide ions (O⁻²) or vice versa. The reactions at the electrodes 12, 14, 18 change the electrical potential at the interface between each of the electrodes 12, 14, 18 and the electrolyte 16, thereby producing an electromotive force. Therefore, the electrical potential difference between any two of the three electrodes 12, 14, 18 can be measured to determine an electromotive force.

The primary reactants at the electrodes of the NH₃ sensing cell 12/16/14 are NH₃, H₂O, and O₂. The partial pressure of reactive components at the electrodes of the NH₃ sensing cell 12/16/14 can be determined from the cell's electromotive force by using the non-equilibrium Nernst Equation (1):

$$emf \approx \frac{kT}{ae} Ln ( {P}_{{NH}_{3}} ) - \frac{kT}{be} Ln ( {P}_{{O}_{2}} ) - \frac{kT}{ce} Ln ( {P}_{{H}_{2} O} ) ) + constant \qquad ( 1 )$$

where:
k=the Boltzmann constant
T=the absolute temperature of the gas
e=the electron charge unit
a, b, c, f, are constant
Ln=natural log
P_{NH}_{₃}=the partial pressure of ammonia in the gas,
P_{O}_{₁}=the partial pressure of oxygen in the gas,
P_{NO}_{₁}=the partial pressure of nitrogen dioxide in the gas
P_{H}_{₂}_{O}=the partial pressure of water vapor in the gas
P_{NO}=the partial pressure of nitrogen monoxide in the gas.

A temperature sensor can be used to measure a temperature indicative of the absolute gas temperature (T). The oxygen and water vapor content, e.g., partial pressures, in the unknown gas can be determined from the air-fuel ratio. Therefore, the processor can apply Equation (1) (or a suitable approximation thereof) to determine the amount of NH₃ in the presence of O₂ and H₂O, or the processor can access a lookup table from which the NH₃ partial pressure can be selected in accordance with the electromotive force output from the NH₃ sensing cell 12/16/14.

The air to fuel ratio can be obtained by ECM (engine control modulus, e.g., see GB2347219A) or by building an air to fuel ratio sensor in the sensor 10. Alternatively, a complete mapping of H₂O and O₂ concentrations under all engine running conditions (measured by instrument such as mass spectrometer) can be obtained empirically and stored in ECM in a virtual look-up table with which the sensor circuitry communicates. Once the oxygen and water vapor content information is known, the processor can use the information to more accurately determine the partial pressures of the sample gas components. Typically, the water and oxygen correction according to Equation (1) is a small number within the water and oxygen ranges of diesel engine exhaust. This is especially true when the water is in the range of 1.5 weight percent (wt %) to 10 wt % in the engine exhaust. This is because the water and oxygen have opposite sense of increasing or decreasing at any given air to fuel ratio and both effects cancel each other in Equation (1). Where there is no great demand for sensing accuracy (such as +0.1 part per million by volume (ppm)), the water and oxygen correction in Equation 1 is unnecessary.

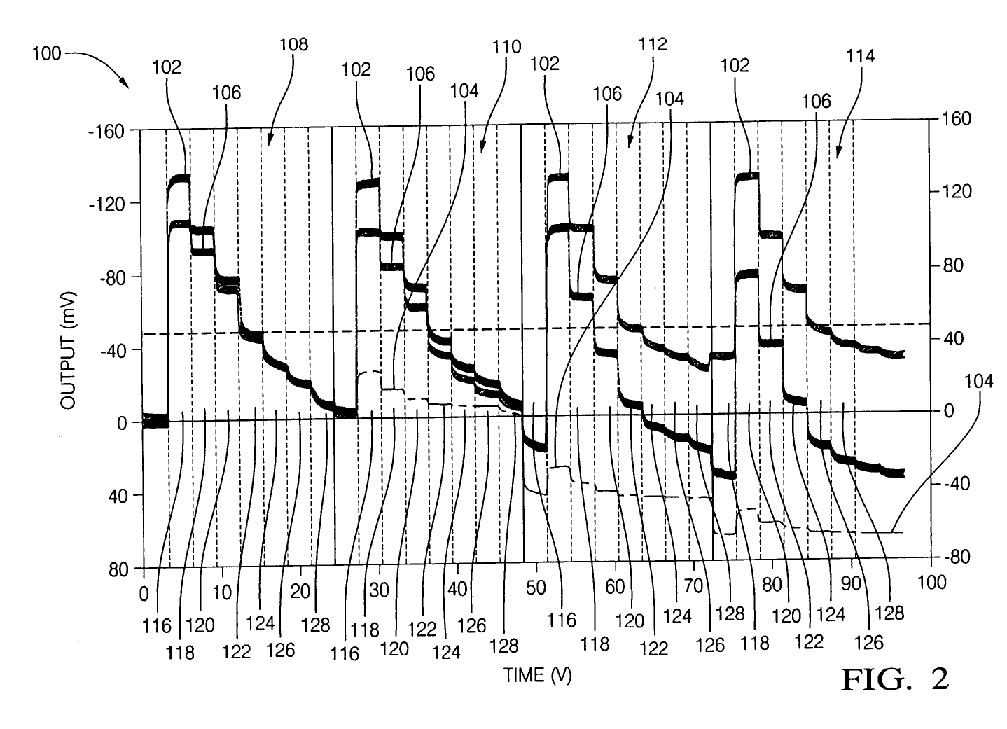

The emf output of the NH₃ cell can be interfered by NO₂ in the sample gas (see FIG. 2). For this reason we use a NOₓ cell to correct this interference effect.

The primary reactants at electrodes of the NO_{X} sensing cell 18/16/14 are NO, H₂O, NO₂, and O₂. The partial pressure of reactive components at the electrodes of the NO_{X} sensing cell 18/16/14 can be determined from the cell's electromotive force by using the non-equilibrium Nernst Equation, Equation (2):

$$emf \approx \frac{kT}{2 e} Ln ( {P}_{NO} ) - \frac{kT}{4 e} Ln ( {P}_{{O}_{2}} ) - \frac{kT}{2 e} Ln ( {P}_{{H}_{2} O} ) - \frac{kT}{2 e} Ln ( {P}_{{NO}_{2}} ) + constant \qquad ( 2 )$$

From Equation (2), at relatively low NO₂ partial pressures, the cell will produce a positive emf. At relatively high NO₂ partial pressures, the cell will produce a negative emf (with electrode 14 set at positive polarity).

The primary reactants at the electrodes of the NH₃ —NO_{X} sensing cell 12/16/14 are NH₃, NO, H₂O, NO₂, and O₂. The partial pressure of reactive components at these electrodes can be determined from the cell's electromotive force by using the non-equilibrium Nernst Equation that takes into account the effect of both Equation 2 and Equation 1.

At relatively high concentrations of NO₂, the NO₂ reacts at both the NH₃ electrode 12 and the NOx electrode 18. Therefore, the electrical potential at the NH₃ electrode 12 due to NO₂ reactions is approximately equal to the electrical potential at the NOx electrode 18 due to NO₂ reactions, resulting in zero overall change in electromotive force due to reactions involving NO₂. Therefore, in the NH₃—NOₓ sensing cell 18/16/12, when the NO₂ concentrations are relatively high, the amount of NH₃ becomes the only unknown in Equation (1). The processor can use emf output of cell 12/16/18 directly (or a suitable approximation thereof) to determine the amount of NH₃ in the presence of O₂ and H₂O, or the processor can access a lookup table from which the NH₃ partial pressure can be selected in accordance with the electromotive force output from the NH₃—NO_{X} sensing cell 12/16/18 and from the air-fuel ratio information provided by the engine ECM. In most diesel exhaust conditions, the O₂ and H₂O effect will cancel each other such that there is no need to do air to fuel ratio correction of the emf output data.

Since at lower NO₂ partial pressures, the NH₃ sensing cell (12/22/14) more accurately detects NH₃, but at higher NO₂ partial pressures, the NH₃—NO_{X} sensing cell (12/22/18) more accurately detects NH₃, the processor selects the appropriate cell according to the selection rule below:

1. Whenever the electromotive force between the NOx electrode 18 and the reference electrode 14 (measured at positive polarity) is greater than a selected emf (e.g., 0 millivolts (mV), +10 mV, or −10 mV), the NH₃ electromotive force is equal to the electromotive force measured between the NH₃ electrode 12 and the reference electrode 14. The selected emf is typically determined from the emf of cell 18/16/14 in the presence of zero NH₃ and NOₓ.

2. Whenever the electromotive force between the NOx electrode 18 and the reference electrode 14 is not greater than the selected emf (e.g., 0 millivolts (mV), +10 mV, or −10 mV), the NH₃ electromotive force is equal to the electromotive force between the NH₃ electrode 12 and the NOx electrode 18.

Referring to FIG. 2, a graphical representation 100 is shown. The tested sensor had a BiVO₄ (5% MgO) NH₃ electrode, a TbMg_{0.2}Cr_{0.8}O₃ NOₓ electrode, and a Pt reference electrode. The sensor was operated at 560° C. The graphical representation includes a line representing the voltage (line 102) across the NH₃ sensing cell, a line representing the voltage (line 104) across the NO_{X} sensing cell, and a line 106 representing the voltage across the NH₃—NO_{X} cell. The graphical representation 100 further includes four sections representing NO₂ and NO concentrations: a first section 108 where NO and NO₂ concentrations are 0 ppm (parts per million), a second section 110 where NO concentration is 400 ppm and NO₂ concentration is 0 ppm, a third section 112 where NO concentration is 200 ppm and NO₂ concentration is 200 ppm, and a fourth 114 section where NO concentration is 0 ppm and NO₂ concentration is 400 ppm. Each of the sections 108, 110, 112, 114, include seven subsections representing NH₃ concentrations: a first subsection 116 where the NH₃ concentration is 100 ppm, a second subsection 118 where the NH₃ concentration is 50 ppm, a third subsection 120 where the NH₃ concentration is 25 ppm, a fourth subsection 122 where the NH₃ concentration is 10 ppm, a fifth subsection 124 where the NH₃ concentration is 5 ppm, a sixth subjection 126 where the NH₃ concentration is 2.5 ppm, and a seventh subjection 128 where the NH₃ concentration is 0 ppm. The remaining gas is composed of 10% O₂, 1.5% of H₂O and balanced by N₂. As shown in FIG. 2, although the line 102 is identical in section 108 and 110, it has a lower value in section 112 and 114 where NO₂ is present.

In an exemplary embodiment, the emf of NOₓ cell at 0 NO_{X} is 0 mV (see line 104 at section 128), therefore the selected emf is a voltage of zero. When NO₂ concentration is 0 ppm as in section 108 and section 110, the voltage (line 104) measured by the sensor across the NO_{X} sensing cell would be greater than 0. Therefore, the sensor would use the voltage (line 102) across the NH₃ sensing cell to determine the NH₃ concentration in the sample gas. When NO₂ concentration is 200 as in section 112 or 400 ppm as in section 114, the voltage (line 104) across the NOₓ sensing cell will not be greater than 0. Therefore, the sensor would use the voltage 106 across the third sensing cell (the NH₃—NOₓ sensing cell) to determine the NH₃ concentration in the sample gas. As can be seen, the line 102 in sections 108 and 110 are almost identical to the line 106 in section 112 and 114, meaning that the NH₃ concentration can be determined without the interference of NO₂.

The sensing element and method disclosed herein enable a more accurate NH₃ determination than was possible when the effects of NOx were not factored into the reading. This sensing element is capable of detecting ammonia at a concentration of 1 ppm without the interference of NOx. The devices have wide temperature ranges of operation (from 400° C. to 700° C.) and are independent of the flow rate of the exhaust. The self-compensation of the water and oxygen interference works for exhaust gas that has a water concentration equal or larger than 1.5%. Below this number, water and oxygen effect correction can be implemented by using Eq. 1, by using the look up table and the air to fuel ratio information provided by the ECM, or by an air fuel ratio sensor that can be a separate sensor or combined with this sensor.

It should be noted that the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced items. As used herein, “combination” is inclusive of blends, mixtures, alloys, reaction products, and the like, as appropriate. The modifier “about” used in connection with a quantity is inclusive of the stated value and has the meaning dictated by the context (e.g., includes the degree of error associated with measurement of the particular quantity). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Finally, unless defined otherwise, technical and scientific terms used herein have the same meaning as is commonly understood by one of skill in the art to which this invention belongs. The suffix “(s)” as used herein is intended to include both the singular and the plural of the term that it modifies, thereby including one or more of that term (e.g., the metal(s) includes one or more metals). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of sensing NH₃ in a gas, comprising:
contacting a NOx electrode with the gas;
determining if a NOx emf between the NOx electrode and a reference electrode is greater than a selected emf; and
if the NOx emf is greater than the selected emf, determining a NH₃ emf between an NH₃ electrode and the reference electrode;
if the NOx emf is not greater than the selected emf, determining the NH₃ emf between the NH₃ electrode and the NOx electrode.

2. The method of claim 1, further comprising measuring a temperature.

3. The method of claim 1, further comprising collecting current at a current collector disposed in electrical communication with the NH₃ electrode.

4. A method of sensing NH₃ in a gas, comprising:
contacting a NOx electrode with the gas; and
determining if a NOx emf between the NOx electrode and a first reference electrode is greater than a selected emf;
if the NOx emf is greater than the selected emf, determining a NH₃ emf between an NH₃ electrode and a second reference electrode;
if the NOx emf is not greater than the selected emf, determining the NH₃ emf between the NH₃ electrode and the NOx electrode.

5. A sensor element, comprising:
an NH₃ sensing cell comprising a NH₃ electrode and a reference electrode, with an electrolyte disposed therebetween and in ionic communication therewith, a first electrical lead in physical contact with the NH₃ electrode, and a reference electrical lead in physical contact with the reference electrode;
a NO_{X} sensing cell comprising a NOx electrode and the reference electrode, with the electrolyte disposed therebetween and in ionic communication therewith, a second electrical lead in physical contact with the NOx electrode, and wherein the NO_{X} sensing cell is capable of detecting a NO_{X} electromotive force; and
a third sensing cell comprising the NH₃ electrode, the NOx electrode, and the electrolyte;
wherein the sensor is capable of sensing ammonia at the NH₃ sensing cell and at the third sensing cell.

6. The sensor of claim 5, wherein the NOx electrode and the NH₃ electrode are disposed in a side-by-side configuration approximately equidistance from a terminal end of the sensor.

7. The sensor of claim 5, further comprising a current collector in physical contact and electrical communication with a periphery of the NH₃ electrode, wherein the current collector is not in physical contact with the electrolyte.

8. The sensor of claim 5, wherein the NOx electrode comprises YbCrO₃, LaCrO₃, ErCrO₃, EuCrO₃, SmCrO₃, HoCrO₃, GdCrO₃, NdCrO₃, TbCrO₃, ZnFe₂O₄, MgFe₂O₄, ZnCr₂O₄, combinations comprising at least one of the foregoing.

9. The sensor of claim 8, wherein NH₃ electrode comprises BiVO₄ and the NO_{X} sensor comprises TbMgCrO₃.

10. The sensor of claim 9, wherein the NO_{X} sensor comprises TbMg_{0.2}Cr_{0.8}O₃
